(19) United States
(12) Patent Application Publication
(10) Pub. No.: US 2018/0234888 A1
(43) Pub. Date: Aug. 16, 2018

(54) USER EQUIPMENT AND DATA TRANSMISSION METHOD

(71) Applicant: NTT DOCOMO, INC., Tokyo (JP)

(72) Inventors: Shimpei Yasukawa, Tokyo (JP); Satoshi Nagata, Tokyo (JP); Qun Zhao, Beijing (CN); Yongbo Zeng, Beijing (CN); Yongsheng Zhang, Beijing (CN)

(73) Assignee: NTT DOCOMO, INC., Tokyo (JP)

(21) Appl. No.: 15/751,196

(22) PCT Filed: Aug. 12, 2016
(86) PCT No.: PCT/JP2016/073742

§ 371 Date: Feb. 8, 2018

(30) Foreign Application Priority Data
Aug. 13, 2015 (JP) 2015-160002

(51) Int. Cl. H04W 28/26; H04W 4/40; H04W 72/02; H04W 72/04

(52) U.S. Cl. CPC H04W 28/26; H04W 4/40; H04W 92/18; H04W 72/0453; H04W 72/02

(57) ABSTRACT

User equipment of a mobile communication system supporting D2D includes a reservation unit that transmits reservation information including reservation resource identification information corresponding to a reservation resource used for data transmission by the user equipment; and a transmitter that transmits data using the reservation resource corresponding to the reservation resource identification information.

### TECHNICAL FIELD

The present invention relates to a technique for transmitting and receiving D2D signals in a mobile communication system supporting D2D.

### BACKGROUND ART

In LTE (Long Term Evolution) and the successor systems of LTE (e.g., LTE-A (LTE Advanced), FRA (Future Radio Access), 4G, etc.), a D2D (Device to Device) technique has been studied, which is for units of user equipment to directly perform communication with each other without going through a radio base station (e.g., Non-Patent Document 1).

D2D reduces traffic between user equipment and a base station; and allows communication between units of user equipment, even if a base station becomes unable to communicate at a time of disaster, etc.

D2D is roughly classified into D2D discovery (D2D discovery, which is also referred to as D2D detection) and D2D communication (D2D direct communication). In the following, when D2D communication, D2D discovery, and so forth are not particularly distinguished, they are simply referred to as D2D. Furthermore, signals transmitted and received in D2D is referred to as D2D signals.

Furthermore, in 3GPP (3rd Generation Partnership Project), it has been studied to achieve V2X by extending a D2D function. As illustrated in FIG. 1, V2X includes V2V (Vehicle to Vehicle) that means a communication mode performed between an automobile (an example of Vehicle) and an automobile; V2I (Vehicle to Infrastructure) that means a communication mode performed between an automobile and a road-side unit (RSU: Road-Side Unit) that is to be installed in a rode side; V2N (Vehicle to Nomadic device) that means a communication mode performed between an automobile and a mobile terminal of a driver; V2P (Vehicle to Pedestrian) that means a communication mode performed between an automobile and a mobile terminal of a pedestrian, and so forth.

### PRIOR ART DOCUMENT

### Non-Patent Document

Non-Patent Document 1: “Key drivers for LTE success: Services Evolution,” September 2011, 3GPP, Internet URL: http://www.3gpp.org/ftp/Information/presentations/pr esentations_2011/2011_09_LTE_Asia/2011_LTE-Asia_3GPP_Service_evolution.pdf
Non-Patent Document 2: 3GPP TS 36.213 V12.4.0 (2014-12)

### SUMMARY OF INVENTION

### Problem to be Solved by the Invention

In V2X, there are critical (urgent, serious) communication related to safety, such as warning information transmission from a vehicle, and normal communication that is not critical.

For critical communication, it is necessary to deliver a signal quickly and reliably to a transmission destination, so that it can be considered that, separately from the normal communication, a channel configuration, etc., is required considering collision prevention, overhead reduction, and so forth. However, in the related art, no channel configuration, etc., has been proposed, considering the critical V2X communication.

Note that, if it is considered that V2X is a type of D2D, the above-described problem is not limited to V2X, and may occur in D2D in general.

The present invention has been achieved in view of the above-described point, and an object is to provide, in a mobile communication system supporting D2D, a technique of D2D communication that is suitable for critical communication.

### Means for Solving the Problem

According to an embodiment of the present invention, there is provided user equipment of a mobile communication system supporting D2D, the user equipment including a reservation unit that transmits reservation information including reservation resource identification information corresponding to a reservation resource used for data transmission by the user equipment; and a transmitter that transmits data using the reservation resource corresponding to the reservation resource identification information.

Furthermore, according to an embodiment of the present invention, there is provided a data transmission method executed by user equipment of a mobile communication system supporting D2D, the data transmission method including a reservation step of transmitting reservation information including reservation resource identification information corresponding to a reservation resource used for data communication by the user equipment; and a transmission step of transmitting data using the reservation resource corresponding to the reservation resource identification information.

### Advantage of the Invention

According to the embodiment of the present invention, in a mobile communication system supporting D2D, a technique of D2D communication is provided that is suitable for critical communication.

### BRIEF DESCRIPTION OF DRAWINGS

FIG. 1 is a diagram for illustrating V2X;

FIG. 2A is a diagram for illustrating D2D;

FIG. 2B is a diagram for illustrating D2D;

FIG. 3 is a diagram for illustrating an example of a channel structure used in D2D;

FIG. 4A is a diagram illustrating an example of a structure of a PSDCH;

FIG. 4B is a diagram illustrating an example of the structure of the PSDCH;

FIG. 5A is a diagram illustrating examples of structures of a PSCCH and a PSSCH;

FIG. 5B is a diagram illustrating example of the structures of the PSCCH and the PSSCH;

FIG. 6A is a diagram illustrating a resource pool configuration;

FIG. 6B is a diagram illustrating a resource pool configuration;

FIG. 7 is a configuration diagram of a communication system according to an embodiment of the present invention;

FIG. 8 is a diagram for illustrating physical channels for V2X critical traffic;

FIG. 9 is a diagram for illustrating an example of reserved operation;

FIG. 10A is a diagram illustrating an example of a data transmission method for each reserved period;

FIG. 10B is a diagram illustrating the example of the data transmission method for each reserved period;

FIG. 11A is a diagram for illustrating an example of MAC PDU transmission in a plurality of subframes;

FIG. 11B is a diagram for illustrating an example of the MAC PDU transmission in the plurality of subframes;

FIG. 11C is a diagram for illustrating an example of the MAC PDU transmission in the plurality of subframes;

FIG. 12 is a diagram for illustrating a process for reducing collisions of reservation information;

FIG. 13 is a diagram for illustrating a problem with half duplexing;

FIG. 14 is a diagram for illustrating an example 1 of a resource selection method;

FIG. 15 A is a diagram for illustrating an example 2 of the resource selection method;

FIG. 15B is a diagram for illustrating the example 2 of the resource selection method;

FIG. 15C is a diagram for illustrating the example 2 of the resource selection method;

FIG. 16 is a configuration diagram of user equipment UE; and

FIG. 17 is a HW configuration diagram of the user equipment UE.

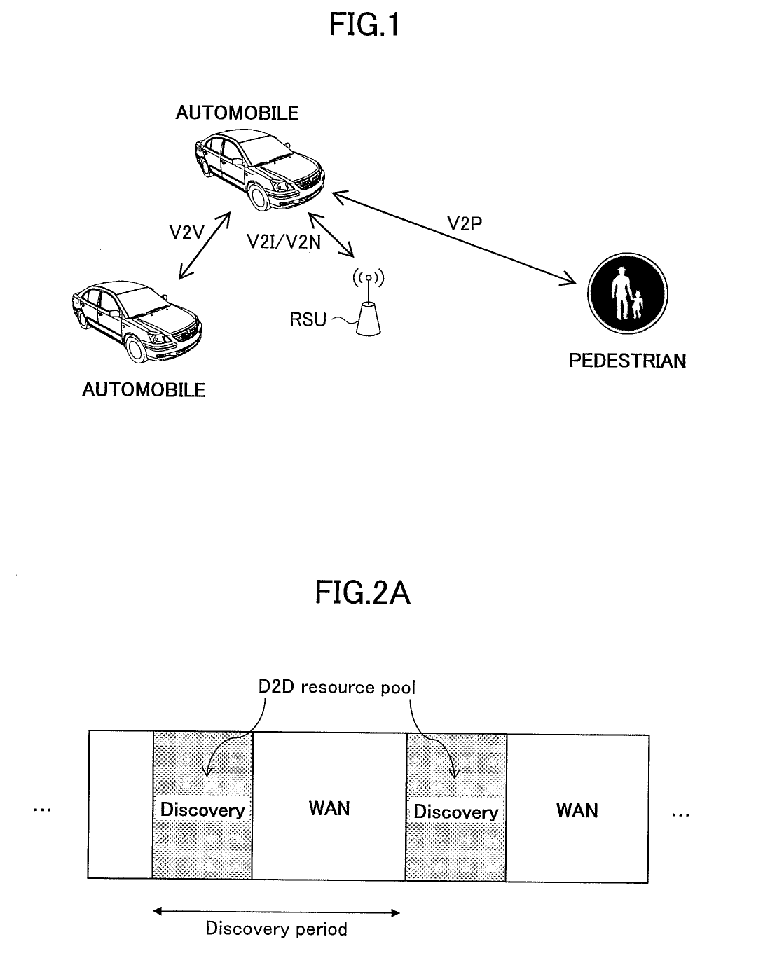

### EMBODIMENTS OF THE INVENTION

In the following, an embodiment of the present invention is described by referring to the figures. The embodiment illustrated below is merely an example; and embodiments to which the present invention is applied are not limited to the following embodiment. For example, it is assumed that a mobile communication system according to the embodiment is a system based on a scheme conforming to LTE; however, the present invention is not limited to LTE, and is applicable to another scheme. Furthermore, in the present invention and in the scope of the claims, “LTE” is used in a broad sense that can include a communication scheme corresponding to Rel-12, 13, or on or after that of 3GPP (including 5G).

Furthermore, the embodiment is intended mainly for V2X; however, a technique according to the present invention is not limited to V2X, and can be broadly applied to D2D in general. In this meaning, “D2D” includes V2X.

In the following, basically, a base station is denoted as “eNB,” and user equipment is denoted as “UE.” The eNB is an abbreviation of “evolved Node B,” and UE is an abbreviation of “User Equipment.”

(Outline of D2D)

The technology of V2X according to the embodiment is based on the technology of D2D specified in LTE, so that an outline of D2D specified in LTE is described first.

In D2D specified in LTE, each UE executes transmission and reception of signals using a part of uplink resources which have already been specified as resources for uplink signal transmission from the UE to the eNB.

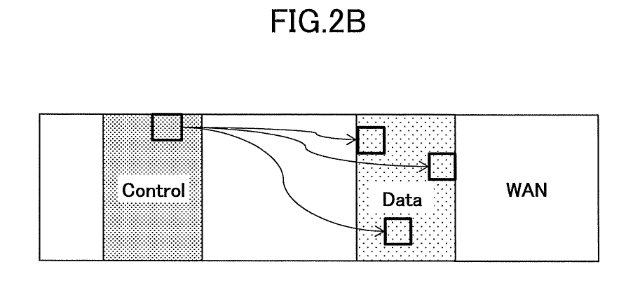

As for “Discovery”, a resource for a Discovery message is reserved for each Discovery period, as illustrated in FIG. 2A; and the UE transmits a Discovery message in the resource pool. More specifically there are Type 1 and Type 2b. In Type 1, the UE autonomously selects a transmission resource from a resource pool. In Type 2b, semi-static resources are allocated by higher layer signaling (e.g., a RRC signal).

For “Communication,” a resource pool for Control/Data transmission is periodically reserved, as illustrated in FIG. 2B. This period (interval) is referred to as a SC period (sidelink control period). The transmitting UE reports a resource for Data transmission, etc., to a receiving side by SCI (Sidelink Control Information) with a resource selected from a Control resource pool (SCI resource pool); and transmits Data with the resource for Data transmission. More specifically, for “Communication,” there are Mode 1 and Mode 2. In Mode 1, resources are dynamically allocated by a (E)PDCCH transmitted from an eNB to UE. In Mode 2, UE autonomously selects a transmission resource from the resource pool for Control/Data transmission. As for the resource pool, one that is reported by a SIB or a predetermined one is to be used.

In LTE, a channel used for “Discovery” is called a PSDCH (Physical Sidelink Discovery Channel); a channel for transmitting control information in “Communication,” such as SCI, is called a PSCCH (Physical Sidelink Control Chanel); and a channel for transmitting data is called a PSSCH (Physical Sidelink Shared Channel) (Non-Patent Document 2).

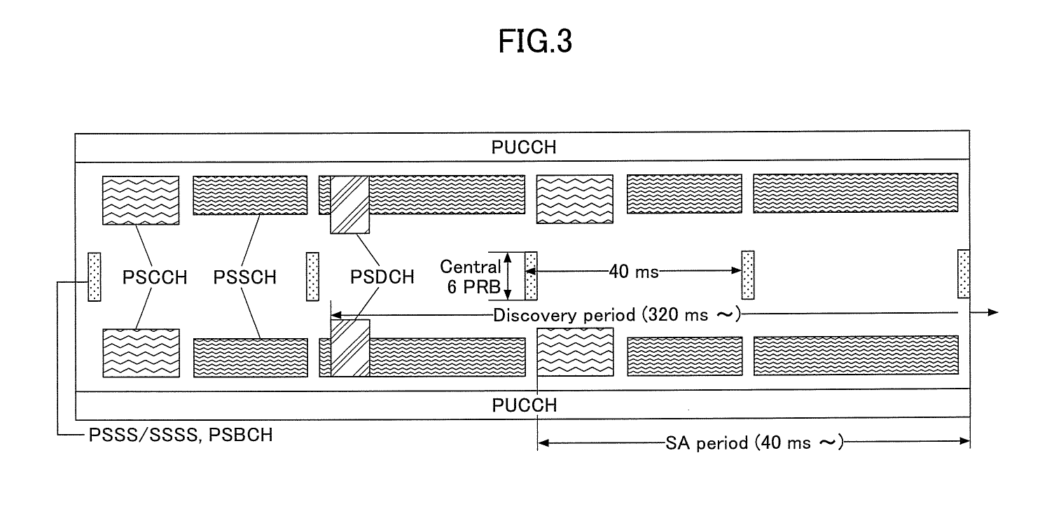

An example of a channel structure of D2D is shown in FIG. 3. As shown in FIG. 3, a PSCCH resource pool used for Communication and a PSSCH resource pool used for Communication are allocated. Furthermore, a PSDCH resource pool used for Discovery is allocated with a period that is longer than a period of the channel of Communication.

Furthermore, PSSS (Primary Sidelink Synchronization) and SSSS (Secondary Sidelink Synchronization) are used as synchronization signals for D2D. Furthermore, for example, a PSBCH (Physical Sidelink Broadcast Channel) for transmitting broadcast information (broadcast information), such as a system band for D2D, a frame number, and resource configuration information, is used for outside coverage operation.

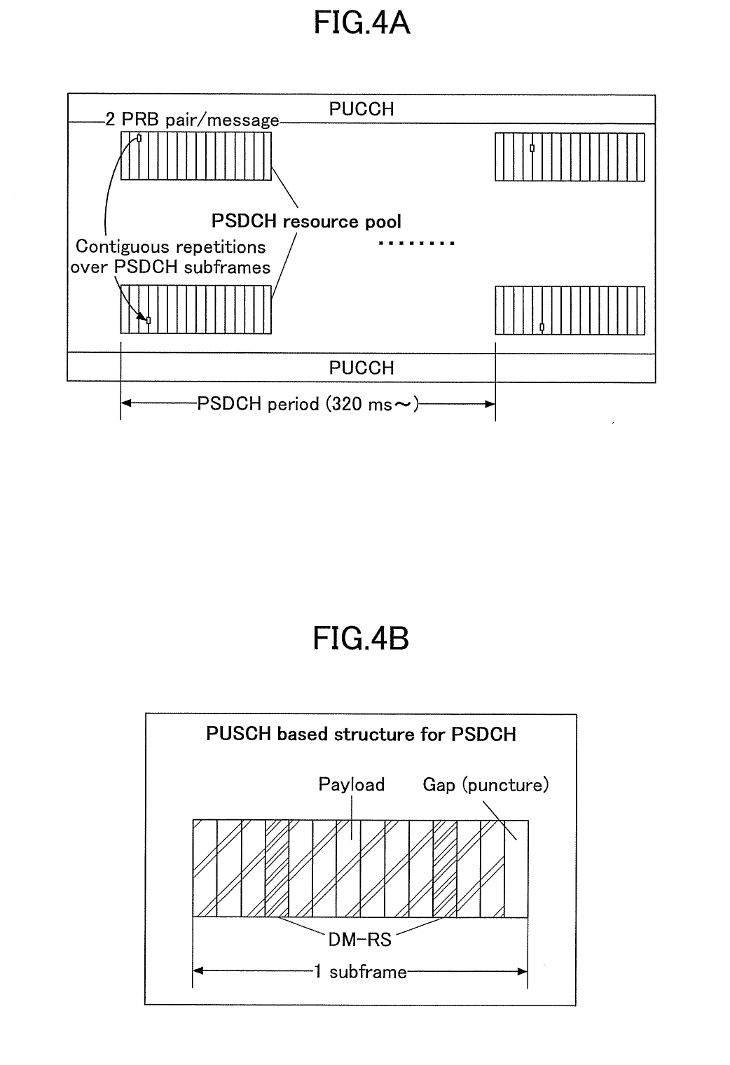

FIG. 4A shows an example of a PSDCH resource pool used for Discovery. Since a resource pool is configured by a bitmap of subframes, the resource pool becomes such that its image is as shown in FIG. 4A. The resource pools for other channels are the same. Furthermore, the PSDCH is repeatedly transmitted (repetition) while being frequency-hopped. The number of times of repetitions can be configured to be from 0 to 4, for example. Furthermore, as shown in FIG. 4B, the PSDCH has a structure based on the PUSCH, and it has a structure in which DM-RSs are inserted.

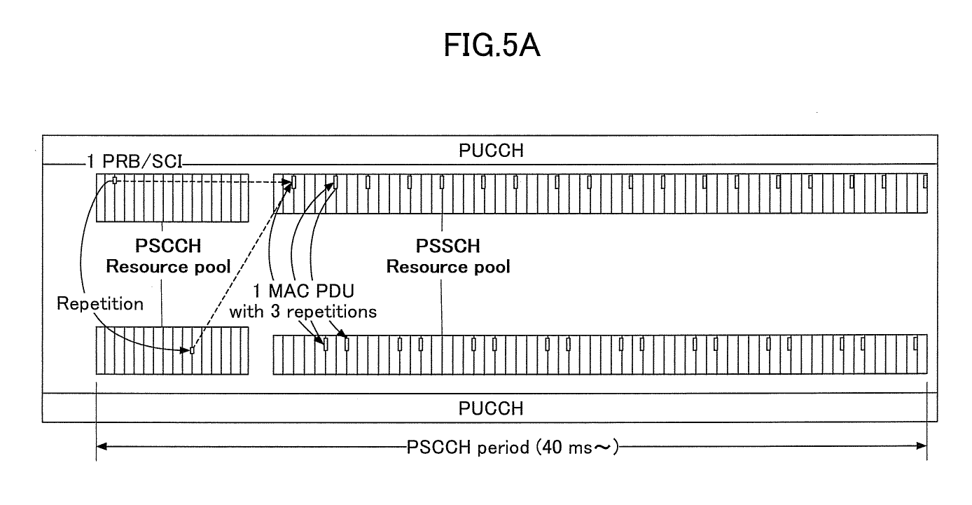

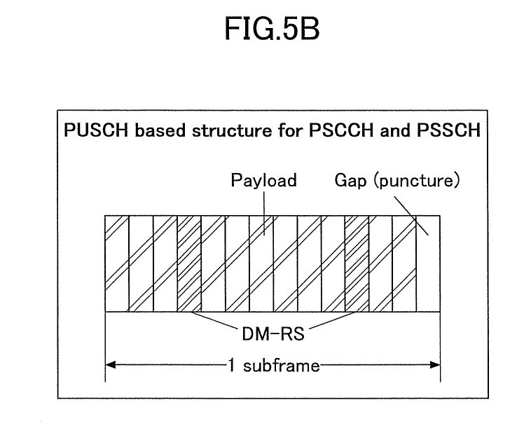

FIG. 5A shows examples of PSCCH and PSSCH resource pools used for “Communication.” As shown in FIG. 5A, the PSCCH is repeatedly transmitted (repetition) once while being frequency-hopped. The PSSCH is repeatedly transmitted (repetition) three times while being frequency-hopped. Furthermore, as shown in FIG. 5B, the PSCCH and the PSSCH respectively have structures based on the PUSCH, and they have structures in which DM-RSs are inserted.

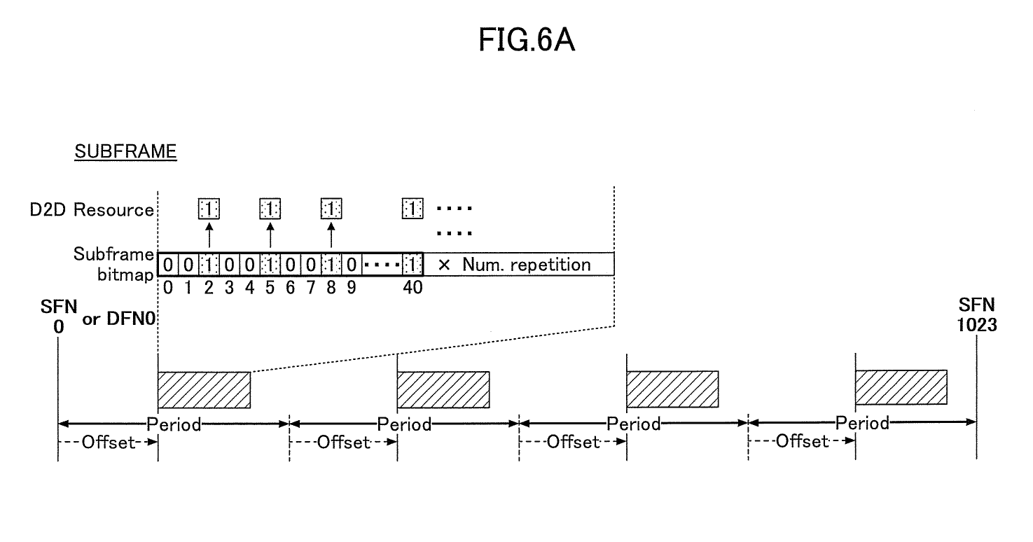

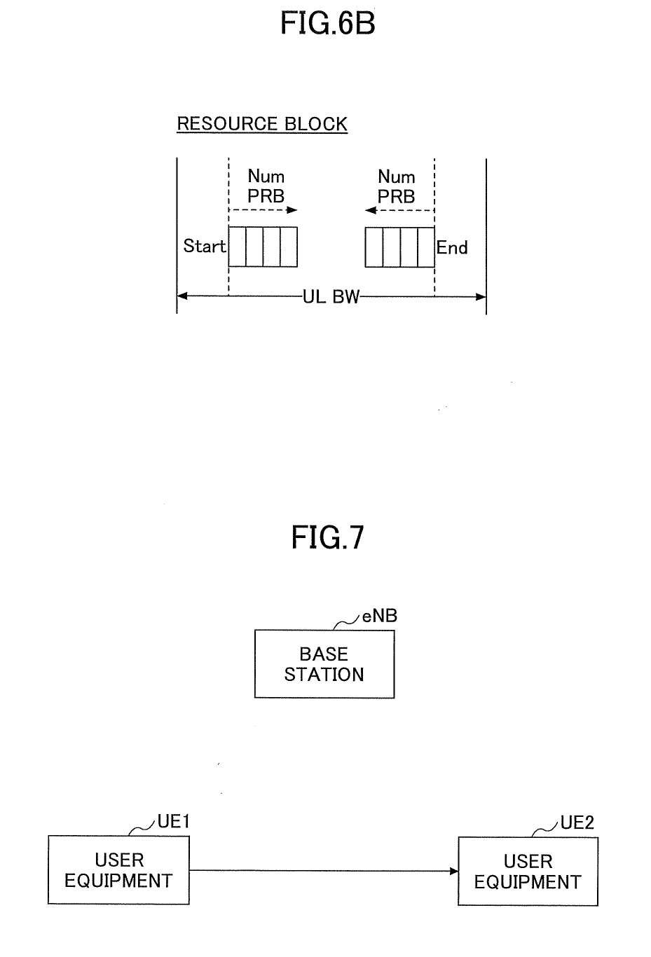

FIG. 6 shows an example of a resource pool configuration for each of the PSCCH, the PSDCH, and the PSSCH (Mode 2). As illustrated in FIG. 6A, in the time direction, the resource pool can be represented as a subframe bitmap. Furthermore, the bitmap is repeated the number of times of num.repetition. Furthermore, an offset is specified that indicates a start position in each period.

In the frequency direction, contiguous allocation (contiguous) and non-contiguous allocation (non-contiguous) are available. FIG. 6B shows an example of non-contiguous allocation; and, as depicted, the start PRB, the end PRB, and the numbers of PRBs (numPRB) are specified.

(System Configuration)

FIG. 7 shows a configuration example of a communication system according to the embodiment. As shown in FIG. 7, an eNB, a UE 1, and a UE 2 are provided. In the following, when the UE 1 and the UE 2 are not particularly distinguished, they are simply described as the UEs. Note that, for example, the eNB performs configuration, etc., of a resource pool for each UE; however, the communication between UEs according to the embodiment is to be performed without going through the eNB.

Each of the UE 1 and the UE 2 shown in FIG. 7 is provided with a cellular communication function as the UE in LTE; and a D2D function including signal transmission/reception through the above described channels. Furthermore, the UE 1 and the UE 2 have functions for executing the operation described in the embodiment. Note that, for the cellular communication function and the existing D2D function, only a part of the function (to the extent that the operation described in the embodiment can be executed) may be included, or all the functions may be included.

Furthermore, each UE may be any device that performs V2X; and, for example, each UE may be a vehicle, a terminal carried by a pedestrian, a RSU, and so forth.

Furthermore, the eNB is provided with a cellular communication function as an eNB in LTE; and a function for enabling V2X (D2D) (e.g., a function for allocating a V2X resource).

(Example of a Physical Channel Configuration)

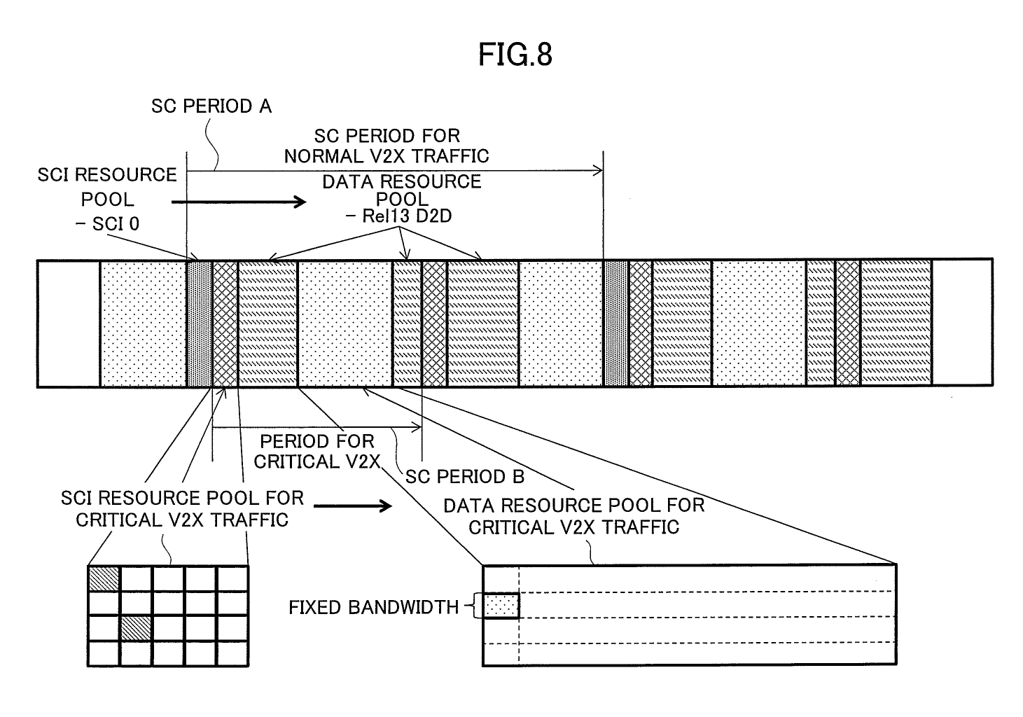

FIG. 8 shows an example of a configuration of a physical channel used by the UE for data transmission and reception in V2X in the embodiment.

In FIG. 8, the horizontal axis direction is the time direction, and the vertical axis direction is the frequency direction. As shown in FIG. 8, a SC period (an interval that periodically occurs) for normal V2X communication is defined; and an SC period for critical V2X communication is defined inside the SC period. As depicted, the SC period for the normal V2X communication is indicated by the SC period A; and the SC period for the critical V2X communication is indicated as the SC period B.

For example, the existing SC period for D2D specified in LTE can be used as the SC period A. In the SC period A, as illustrated in FIG. 8, allocation of a data resource can be executed by using the SCI in the SCI resource pool (the existing SCI format 0). Note that the SCI for performing data resource allocation may be referred to as a SA (Scheduling Assignment).

Here, the SC period B is shorter than the SC period A. As an example, the SC period A is 40 ms or more; and the SC period B is 10 ms or 20 ms. By using such a short period (period), latency can be suppressed.

Furthermore, as shown in FIG. 8, a resource for the normal V2X communication (example: a normal D2D resource) is not to be overlapped with a resource for the critical V2X communication, and they are caused to be orthogonal (orthogonal) to each other, so that collision between the critical V2X communication and the normal V2X communication can be avoided.

As described below, in the embodiment, a data resource for the critical V2X communication can be semi-statically (semi-statically) allocated. By such semi-static allocation, reliability can be enhanced.

Thus, in the embodiment, a new SCI format that allows reservation (reservation) of a resource is defined as a format of the SCI (information for data resource allocation for the critical V2X communication) to be transmitted with a resource of the SCI resource pool in the SC period B.

Specifically, the SCI includes reservation resource identification information (Reservation resource indication), a timer value, and so forth. Additionally, a destination ID and a MCS may further be included. Note that the reservation resource identification information, the timer value, and so forth are collectively referred to as reservation information.

The above-described timer value is a value indicating a temporal length (example: a number of times of transmission) until the reservation is terminated; and the timer value is applied to both the resource of the SCI and the data resource allocated by the SCI. Furthermore, the timer value may be applied only to the data resource. An example of the reservation operation using the timer value is described below.

As illustrated in FIG. 8, in the data resource pool for the critical V2X communication, a resource with a fixed bandwidth (a predetermined bandwidth) is allocated, as a resource for data transmission. Furthermore, the time resource may also be a fixed length (a predetermined length, e.g., one subframe). Namely, as a data resource for the critical V2X communication, a resource with a fixed size is allocated. Note that, for example, an integer multiple size of a fixed size may be allowed, instead of completely fixing the data resource. Furthermore, as for the transmission power for performing transmission with the resource (the resource block), fixed transmission power may be used that does not depend on path loss for the interval to the eNB.

As for the SCI and data for the critical V2X communication, retransmission (the SCI is to be retransmitted once, and data is to be retransmitted three times) may be performed similar to the above-described retransmission in D2D (e.g., FIG. 5), or retransmission that is different from the retransmission in the existing D2D may be performed.

(Operation Example for Reservation)

In the following, an operation example for reservation is described in more detail. In the following, the SC period, the SCI, the data, the data resource, and so forth indicate those for the V2X communication, unless as otherwise indicated. Furthermore, the following operation is an operation corresponding to “Communication” of Mode 2 in D2D.

As described above, in the embodiment, a new SCI format is defined for the critical V2X communication; and reservation resource identification information and a timer value are included, as the reservation information for implementing semi-static allocation, in the SCI having the format.

The reservation resource identification information indicates, for example, a time-frequency position of a reserved (reserved) resource. As described above, since the resource size is fixed, it suffices to specify the position information. As an example, the reservation resource identification information is formed of a frequency position and a T-RPT (Time Resource Pattern). The pattern of the T-RPT is a pattern indicating a time position (e.g., a subframe position) of the data resource (the transmission resource) including retransmission. However, to use the T-RPT as the information indicating the time position is merely an example, and the time position may be indicated by using any other indication information. Furthermore, reservation information for the subsequent SCI transmission resource may be reported. In this case, collision of the SCI can be avoided; and, by only reserving the time-frequency resource of the transmission data, and by changing the MCS for each SCI transmission, the transmission data size can be changed.

The timer value (the initial value of the timer) is a value indicating a count value until the termination of the reservation. The UE includes a timer; and, for example, when the UE performs data transmission, the timer value is configured in the timer for sending the SCI with the reservation information for the first time, after selecting the data resource (the resource to be reserved). The timer value (an initial value and a length of the timer) is configured, for example, by a higher layer (e.g., the RRC signaling from the eNB), as a random value within a certain range [Train, Tmax].

Furthermore, a resource position for transmitting the SCI with the reservation information is also selected in the SCI resource pool within the SC period.

The timer value in the above-described timer is decremented each time the SCI is transmitted from the UE; and, upon detecting that the timer value reaches zero (when the timer has expired), the reservation is terminated, and the reserved resource is released. If the UE still has transmission data, the UE selects a data resource again, and performs allocation. Upon transmitting the reservation information for the reselected resource, an initial value is configured in the timer, and it is to be decremented for each SCI transmission, similar to above. Furthermore, reselection/reallocation is performed for the resource for transmitting the SCI (reservation information).

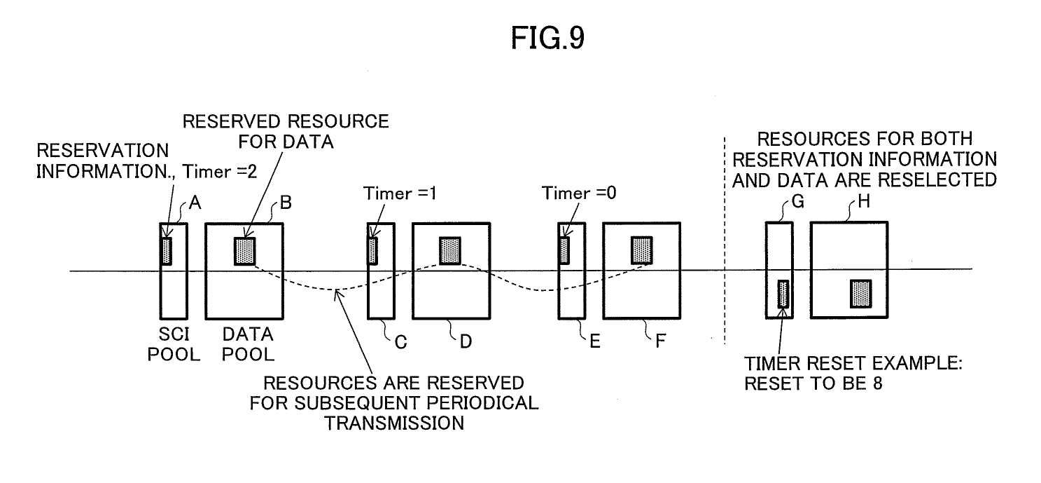

A specific example is described by referring to FIG. 9. In the example illustrated in FIG. 9, the UE first selects a resource in the SCI resource pool indicated by A; and transmits the SCI (reservation information) with the resource. The initial timer value (initial value) is 2. Then, in the data resource pool indicated by B, the UE transmits data using the data resource (the reserved resource) identified by the reservation resource identification information in the reservation information.

Note that, since the receiving UE that receives the reservation information can find the position of the reserved data and the timer value by the reservation information, the number of times that the data can be received with the data resource can be found.

Subsequently, in the SCI resource pool indicated by C, the UE transmits the SCI (the reservation information). At this time point, the timer value is decremented by 1, so that the timer value maintained by the UE for the reservation resource becomes 1. The reservation information to be transmitted may include the timer value=1, or may not include it; and FIG. 9 shows the example where it is included. Even if the timer value=1 is not included, the timer value can be decremented at the receiving side by receiving data through the reserved resource.

Then, in the data resource pool indicated by D, the UE transmits data using the data resource identified by the reservation resource identification information in the reservation information.

In the example illustrated in FIG. 9, in the reservation period (the period in which the timer value is not 0), the reservation information, such as the SCI transmission for the second time, may not be transmitted. The reason is that the receiving side can find that the data resource is reserved for the predetermined time period by the initial reservation information; and that data reception can be performed using the data resource during the time period. Even in this case, the timer value is decremented at each timing for transmitting the reservation information. Furthermore, during the reservation period, the SCI that does not include the reservation information and that only includes information that can be changed for each transmission (e.g., MCS) may be transmitted.

Furthermore, as the SC period for transmitting the reservation information/data illustrated in FIG. 9, each SC period that periodically occurs may be used; or another SC period that occurs with a occurrence period that is longer than that of the SC period may be used.

In the example of FIG. 9, the timer value becomes zero at the time point at which the UE transmits the SCI (reservation information) in the resource pool indicated by E. Consequently, in the subsequent transmission (G, H), a SCI resource and a data resource are newly selected, and SCI transmission and data transmission are continued.

Note that “reservation” in the embodiment implies that the transmitting UE at the side of transmitting the reservation information/data uses the resource that is the same for a certain time period or that is based on a constant time/frequency pattern to transmit the reservation information/data; and the receiving UE at the side of receiving the reservation information/data expects (receives) the reservation information/data through the resource that is the same for the certain time period or that is based on the constant time/frequency pattern. The “reservation” of the resource is not to be effective for a UE other than the transmitting UE and the receiving UE. Namely, the UE other than the transmitting UE and the receiving UE can use the resource reserved for the transmitting UE and the receiving UE. However, in this case, the collision of the resource occurs, so that, in the embodiment, each UE can perform resource selection (selection of a resource to be reserved) to avoid the collision of the resource, as described below.

Furthermore, in the above-described example, by counting the number of times of transmitting the reservation information (or data), the expiration of the time period of reservation is detected; however, this is an example. For example, time (e.g., time in units of 1 ms) may be specified as the timer value; and the reserved resource may be released at a time point at which the time of the timer value has elapsed from the transmission (reception) of the first reservation information/time.

(Advantage of Using the Fixed Size Resource)

As described above, in the embodiment, the size of the resource to be reserved for data transmission is fixed.

Consequently, measurement (measurement) is facilitated; and, for example, it becomes easier to find whether the resource at the position to be allocated is used by another UE. Furthermore, the number of bits required for specifying the fixed size resource can be small, so that reservation of the resource can be easily made.

However, for example, if a resource with a fixed bandwidth is to be used for each subframe, the number of bits that can be transmitted by one subframe is to be limited, so that it may become difficult to support the flexible packet size and data rate. In view of this point, in the embodiment, a technique is introduced that allows, even if the fixed bandwidth is to be used, the flexible packet size and data rate, as described below.

(Implementation of a Flexible Transmission Rate)

In the embodiment, a reservation period (reservation period) can be used that indicates a period for transmitting the reservation information/data for a reserved resource. The reservation period may be the same as or different from the SC period for the critical communication; however, for example, the reservation period may be an integral multiple of the SC period (multiple of SC period). The integer value indicating which multiple may be fixed, or may be configured (configure) by the eNB.

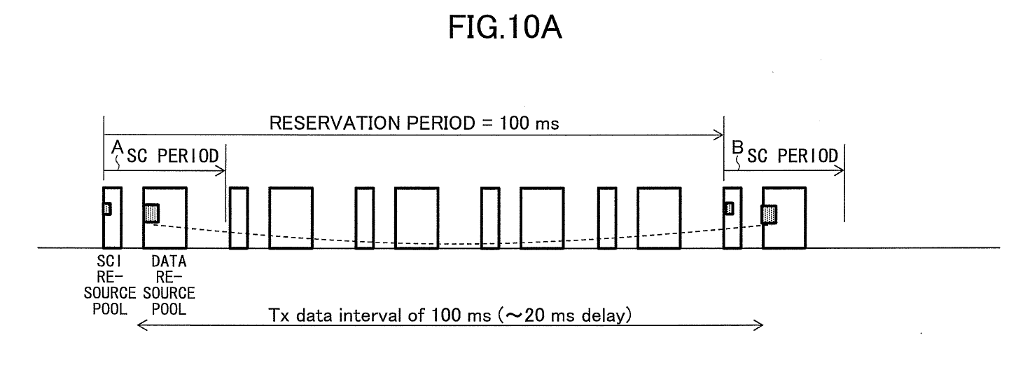

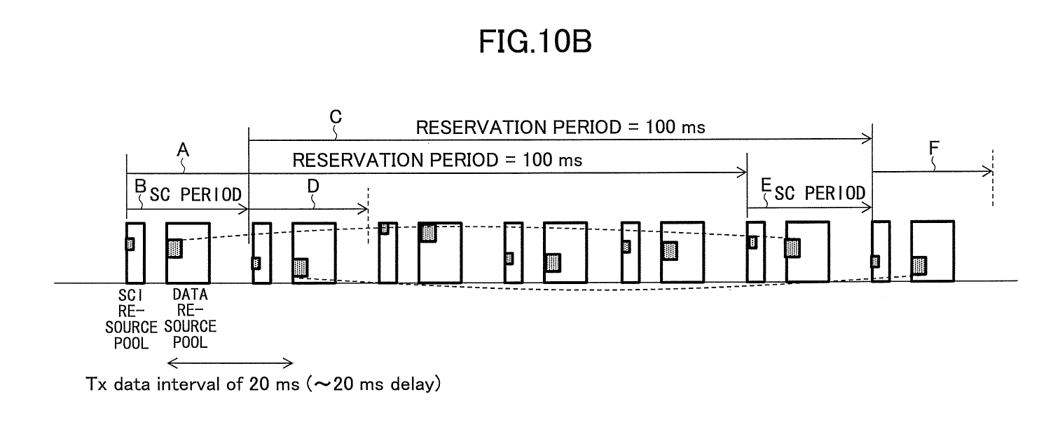

FIGS. 10A and 10B show an example of the reservation period. In each of FIGS. 10A and 10B, the example is illustrated in which the SC period is 20 ms and the reservation period is 100 ms.

In the case of FIG. 10A, the first reservation information/data is transmitted in the SC period indicated by A in the first reservation period. During the interval in which the above-described timer does not expire, the reservation is effective in each reservation period; and, in the example of FIG. 10A, the subsequent reservation information/data is transmitted in the SC period indicated by B in the next reservation period (the time position in the reservation period is the same as the SC period indicated by A) by using the resource that is the same as the resource used for the first time.

If the reservation is effectuated for each SC period (e.g., for each 20 ms) without using the concept of such a reservation period, and the data transmission period in the reserved resource is longer than the SC period (e.g., 100 ms), a resource occurs that is only reserved without performing data transmission, so that a waste of the resource occurs. In contrast, by introducing the reservation period as in the embodiment, occurrence of such a waste can be prevented.

For example, in the case of FIG. 10A, in SC periods other than the SC period (the SC periods indicated by A and B) related to the reservation of each reservation period, there is no reservation of the resources, so that they can be used for any other communication. Namely, the reservation is effective for each of the SC periods separated by the reservation period.

Furthermore, by using the transmission method shown in FIG. 10B, even if the reservation period longer than the SC period is to be used, the UE can transmit data related to the reserved resource with a flexible transmission rate.

In the example shown in FIG. 10B, separate reservation periods (each reservation period occurs in the period of the reservation period) are provided in units of the SC period (it is provided while being shifted by the SC period). The UE transmits, in the reservation period indicated by A (which is referred to as the reservation period A) that is one of the separate reservation periods, the reservation information/data in the SC period indicated by B. In the SC period indicated by E in the period subsequent to the reservation period A, the reservation information/data is transmitted using the same resource. Furthermore, in the reservation period indicated by C (which is referred to as the reservation period C), the reservation information/data is transmitted in the SC period indicated by D; and in the SC period indicated by F in the period subsequent to the reservation period C, the reservation/data is transmitted using the same resource.

In the above-described example, the reservation periods are provided in units of the SC period; however, by increasing the length of this unit, the transmission data rate can be decreased. In this manner, by using the reservation period, the flexible transmission rate can be implemented.

(MAC PDU Transmission by Multiple Subframes)

In LTE, in general, a higher layer PDU (protocol data unit) with a large size is divided into a plurality of MAC PDUs, and each of the MAC PDUs is transmitted in one subframe.

However, when the large-size data is to be divided into a plurality of MAC PDUs, the MAC header attached to each MAC PDU increases the overhead (protocol cost). Especially, considering the fixed bandwidth transmission in the embodiment, such an increase in the overhead is not preferable.

In the embodiment, in order to reduce the cost of the MAC header, the UE accommodates data with a large size in a large MAC PDU; divides the MAC PDU into multiple partial data items; and transmits these. Each partial data item is transmitted in one subframe.

For performing the above-described transmission, the UE includes the value of the number of the multiple partial data items in the SCI (reservation information) so as to complete the transmission of one (a single) MAC PDU.

Regarding each partial data item of the divided MAC PDU, two partial data items belonging to different MAC PDUs, respectively, are not to be combined at the receiving side. Furthermore, the multiple partial data items in the one MAC PDU are to be transmitted in a single SC period. However, the multiple partial data items of the one MAC PDU may be transmitted in multiple SC periods.

Furthermore, when transmission is to be performed while dividing it into multiple partial data items, the number of times of retransmission per one MAC PDU may be reduced depending on the number of the partial data. For example, suppose that, if no division is applied, the number of times of retransmission of the MAC PDU is four. Then, if the number of the divisions is two, each partial data item may be transmitted two times (one is the transmission for the first time, and the other one is the retransmission).

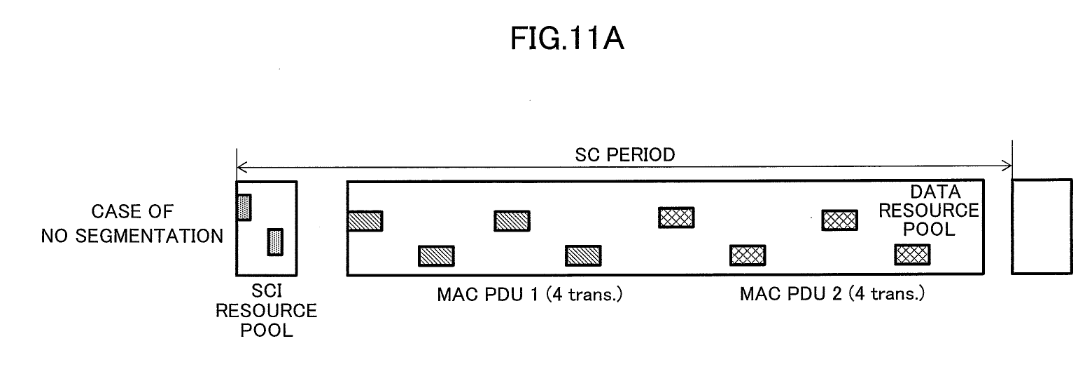

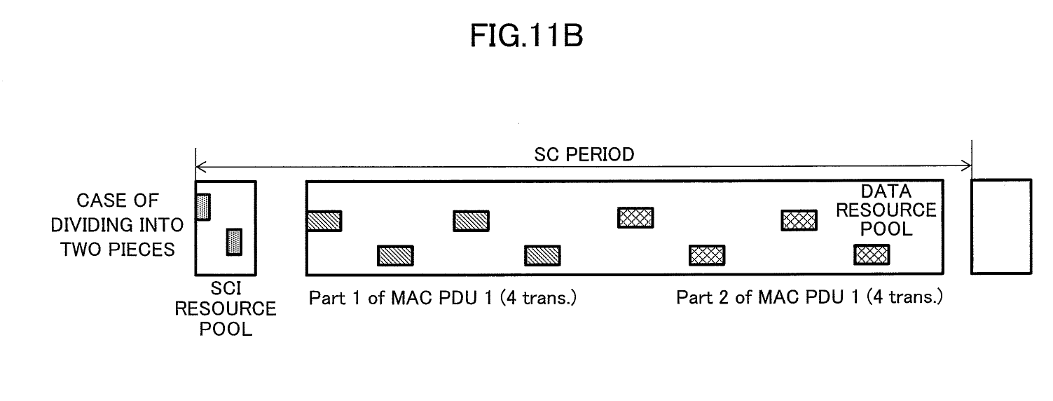

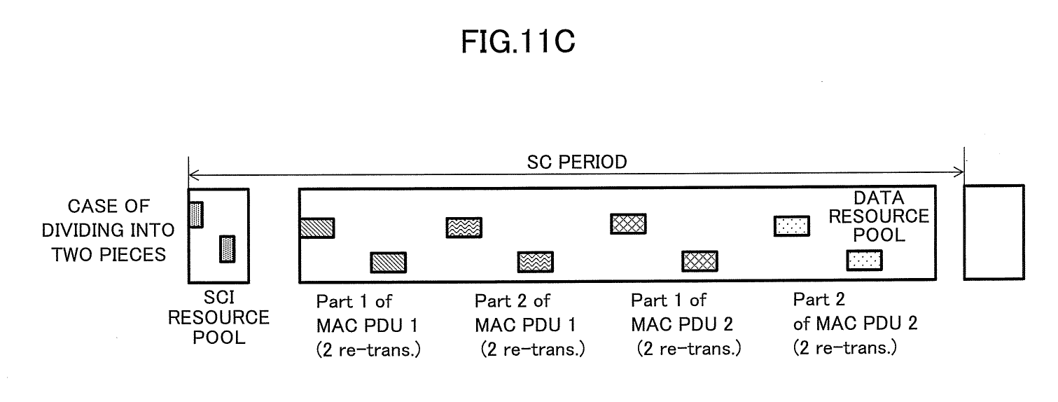

Specific examples are shown in FIGS. 11A, 11B, and 11C. Each of FIGS. 11A, 11B, and 11C shows a certain SC period. Furthermore, it is assumed here that eight subframes are to be allocated (reserved) for data transmission in one SC period.

FIG. 11A is an example of a case where the MAC PDU is not divided. Furthermore, the UE transmits two MAC PDUs here, which are the MAC PDU 1 and the MAC PDU 2. In this example, each SCI for transmission of the corresponding MAC PDU includes “1,” as the number of the partial data item. Here, “1” indicates that no division is to be applied.

As illustrated in the data resource pool of FIG. 11A, for each MAC PDU, transmission is performed four times.

FIG. 11B is an example of a case where, when one MAC PDU is to be transmitted in one SC period, the MAC PDU is divided into two parts. As illustrated in the data resource pool of FIG. 11B, for each divided partial data item, transmission is performed four times. Furthermore, each SCI for transmission of the corresponding partial data item includes “2,” as the number of the partial data items. Here, “2” indicates that the MAC PDU is divided into two parts.

FIG. 11C is an example of a case where, when two MAC PDUs are to be transmitted in one SC period, each MAC PDU is to be divided into two parts. As illustrated in the data resource pool of FIG. 11C, for each divided partial data item, transmission is performed two times. Furthermore, each SCI for transmission of the corresponding MAC PDU includes “2,” as the number of the partial data items. Here, “2” indicates that the MAC PDU is divided into two parts.

(Reduction of the Collision of the Reservation Information)

In the embodiment, when the UE transmits the SCI (reservation information, hereinafter) including the reservation information in the SCI resource pool in the SCI period, the UE may optionally select a resource for transmitting the reservation information; however, in this case, the collision with reservation information transmitted by another UE may occur.

Thus, the UE according to the embodiment performs monitoring (listen) and measurement of the reservation information transmitted from the other UE in the SCI resource pool; and selects a resource that can be estimated that the other UE does not transmit the reservation information with it, and transmits the reservation information.

More specifically, the UE attempting to perform data transmission measures the received power (received energy) of signals received with corresponding resources in the SCI resource pool in the reservation period prior to selecting the resource of the reservation information (SCI); and selects, for example, a resource with the received power that is less than or equal to a predetermined threshold value, and transmits the reservation information. If there are multiple resources with the received power that is less than or equal to the predetermined threshold value, one resource may be optionally selected from them.

Furthermore, if there is no resource with the received power that is less than or equal to the predetermined threshold value, the resource with the minimum received power may be selected as the resource of the reservation information, for example.

As described above, upon detecting expiration of the timer maintained by the UE, the resource for the reservation information is released together with the data resource, and a new resource is selected.

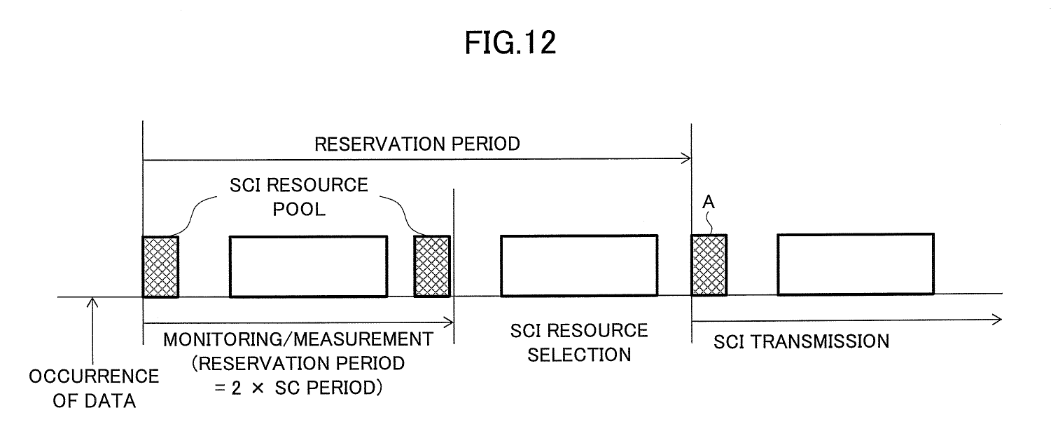

A specific example is described by referring to FIG. 12. In the example of FIG. 12, the reservation period is configured as 2×SC period. In this case, first, the UE performs monitoring and measurement in the two SCI resource pools in the reservation period; and selects a resource for transmitting the reservation information from the SCI resource pool. Then, in the SCI resource pool (which is indicated by A in FIG. 12) in the subsequent reservation period, the reservation information is transmitted using the selected resource.

(Resolution of the Half Duplex Problem)

In D2D communication including V2X, the UE performs half duplex (Half duplex) communication, where transmission and reception are not to be performed at the same time (e.g., in one subframe). For example, when the UE 1 and the UE 2 transmit signals in the same subframe, the UE 1 may not receive the signal from the UE 2, and the UE 2 may not receive the signal from the UE 1. Accordingly, for the embodiment in which semi-static resource allocation is to be performed, a problem is that the period during which reception may not be performed between the UEs may continue.

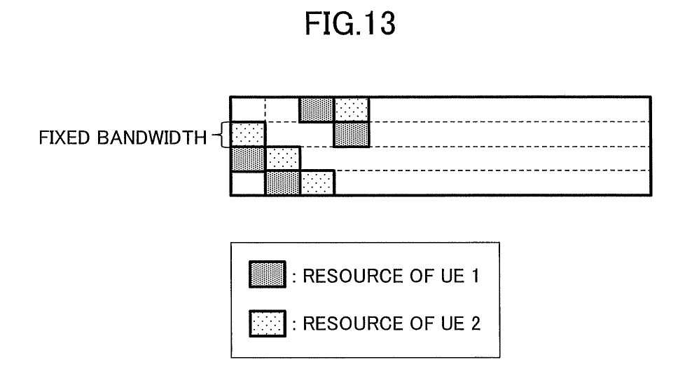

The problem is described by referring to FIG. 13. As shown in FIG. 13, the time positions (subframes) of the resources that are semi-statically allocated in the UE 1 and the UE 2 overlap; and, at these time positions, the UE 1 and the UE 2 may not receive signals from the other parties, respectively. Depending on the time length in which the reservation of the resources continues, such a situation may continue for a long time.

In order to solve the above-described problem, the UE may perform any one of Option 1 and Option 2 below.

<Option 1>

Option 1 introduces time-frequency hopping in the data resource pool. As for the time-frequency hopping, an existing hopping rule (e.g., the rule used for the existing SCI) may be applied; or a new rule may be introduced.

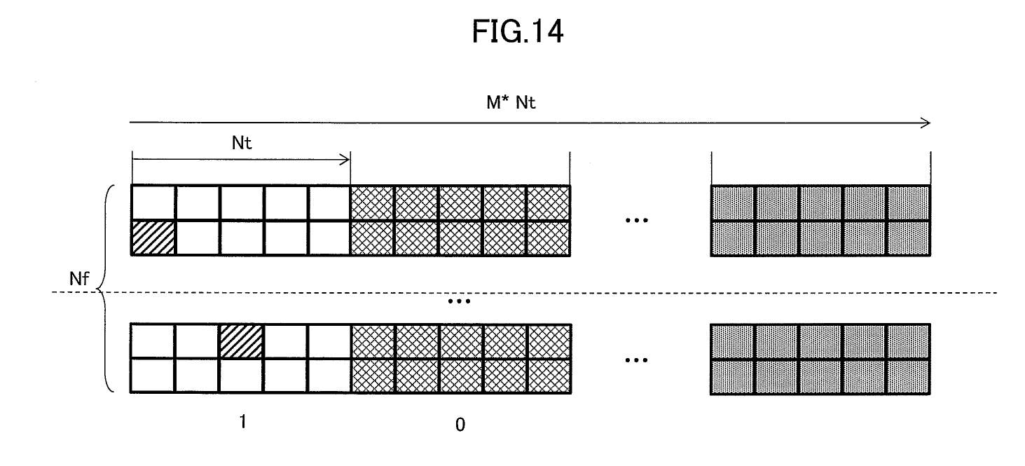

FIG. 14 shows an example of time-frequency hopping in Option 1. In the example illustrated in FIG. 14, the portion indicated by Nf (frequency length)×M*Nt (time length) shows the data resource pool in the SC period. As depicted, the data resource pool is divided into sub-pools formed of Nf×Nt resources. In the example of FIG. 14, M=8, and the T-PRT pattern specifies to which sub-pool a data resource is to be allocated. For example, if T-PRT={10011001}, the first sub-pool (the leftmost sub-pool in FIG. 14) corresponds to “1” of the pattern, and corresponds to the sub-pool to which a data resource is to be allocated. Then, in each sub-pool, for example, hopping is to be performed by the hopping method of the existing SCI (SA). Furthermore, the hopping method may be performed by another method.

By such hopping, the resource of the data to be transmitted by the UE in each SC period is time-hopped, so that the likelihood of occurrence of the Half duplex problem can be reduced.

Note that FIG. 14 shows the case where M=8; however, if M<8, the first M bits of T-PRT={1001101} are to be made effective. Furthermore, if M>8, for example, the pattern of the T-PRT may be repeatedly used.

<Option 2>

In Option 2, by detecting the allocation state in the data resource pool, the UE selects a resource other than the already allocated resource.

More specifically, by measuring the received power (received energy) at each resource in the data resource pool prior to selecting a resource for data transmission, the UE selects, for example, the resource with the received power that is less than or equal to a predetermined threshold value (the resource that can be estimated not to be used by another UE). Furthermore, by receiving the SCI (reservation information) from another UE, the UE may find the resource allocated by the other UE in the data resource pool, and may select a resource other than that resource.

The UE determines, as the resource to be allocated for the data transmission, the frequency position and the time position of the resource that does not collide with the resource of the other UE; and performs allocation. Note that the time position may be determined as the T-PRT pattern. For the resource selection here, the time position (subframe) is not to be overlapped with the resource related to another reservation.

Furthermore, first, a T-PRT pattern may be selected, so that the time position does not overlap with that of another resource; and, then, the frequency position may be selected.

Note that, when an amount of the resources with the received power that is less than or equal to the predetermined threshold value is not sufficient, among the resources with the received power that is greater than the predetermined threshold value, the resource with the minimum received power may be selected as the selection candidate.

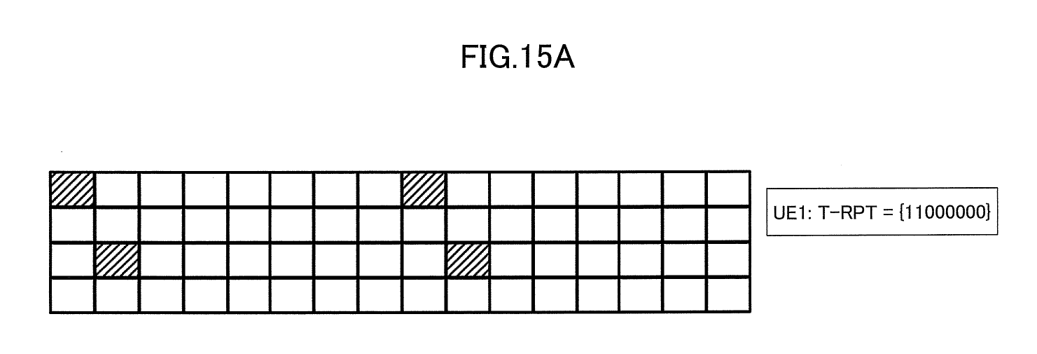

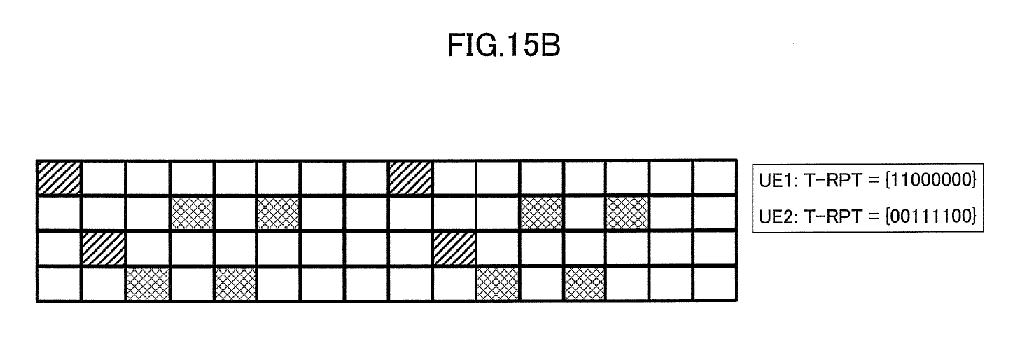

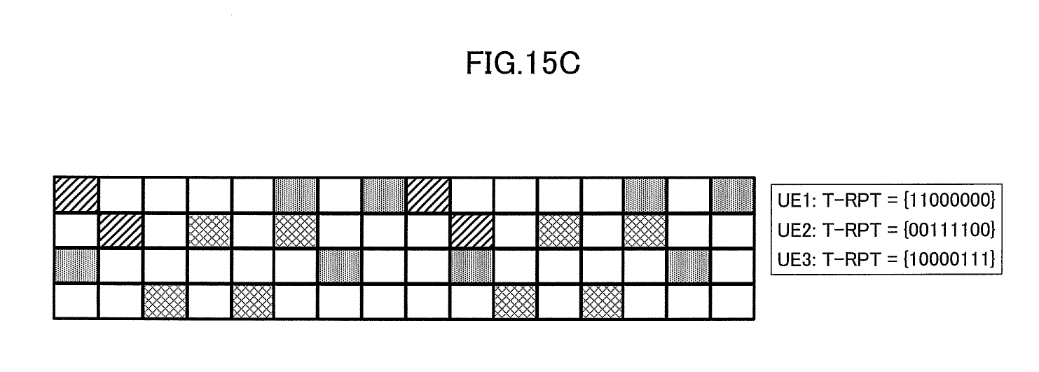

Specific examples are shown in FIGS. 15A through C. Here, it is assumed that the UE 1, the UE 2, and UE 3 are performing resource selection. In the initial state shown in FIG. 15A, the UE 1 reserves the resources at the time positions indicated by T-RPT={11000000}. In the subsequent state shown in FIG. 15B, as a result that the UE 2 finds the UE 1's reserved resources, the UE 2 determines T-RPT={0011100}, whose time positions do not overlap with those of the UE 1's resources. Furthermore, in the subsequent state shown in FIG. 15C, the UE 3 determines T-RPT={10000111}, so that the time positions do not overlap as much as possible.

(Device Configuration)

<Configuration Example of UE>

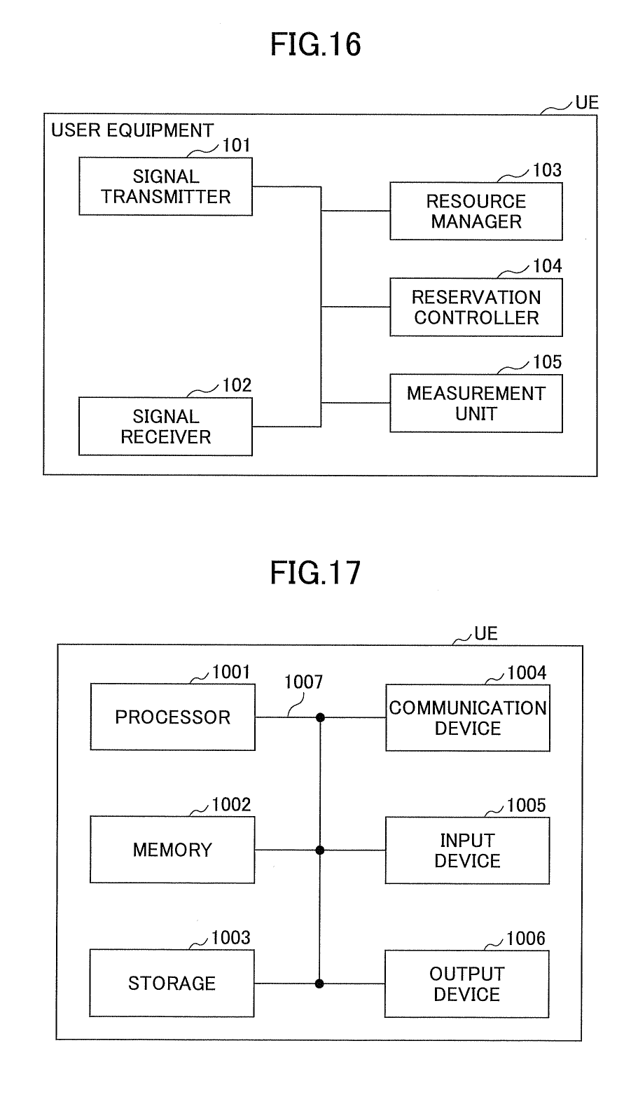

FIG. 16 shows a functional configuration diagram of the UE according to the embodiment. The UE illustrated in FIG. 16 is capable of executing all the processes of the UE described above. However, a part of the processes of the UE described above may be executable. In the following, main functions are described.

As shown in FIG. 16, the UE includes a signal transmitter 101; a signal receiver 102; a resource manager 103; a reservation controller 104; and a measurement unit 105. Note that FIG. 16 only shows, in the user equipment UE, functional units that are particularly related to the embodiment of the present invention; and at least functions, which are not depicted, for executing operation conforming to LTE are also included. Furthermore, the functional configuration illustrated in FIG. 16 is merely an example. The functional division and names of functional units may be any division and names, provided that the operation according to the embodiment can be executed. Furthermore, the UE is a device that can be any device included in a V2X system when it is applied to the V2X. For example, the UE may be a vehicle, a RSU, a terminal carried by a pedestrian, and so forth.

The signal transmitter 101 includes a function for generating various types of physical layer signals from one or more higher layer signals to be transmitted from the user equipment UE, and for wirelessly transmitting them. Furthermore, the signal transmitter 101 includes a transmission function for D2D (including V2X); and a transmission function for the cellular communication.

The signal receiver 102 includes a function for wirelessly receiving various types of signals from another UE, an eNB, and so forth, and for retrieving a higher layer signal from a received physical layer signal. The signal receiver 102 includes a reception function for D2D (including V2X); and a reception function for the cellular communication.

The resource manager 103 maintains information on a resource pool used for data transmission/reception in the UE, etc., based on a configuration from an eNB or a RSU, for example. The information on the resource pool is used for data transmission/reception by the signal transmitter 101/signal receiver 102. Furthermore, the resource manager 103 includes, for example, a function for selecting a specific resource from the resource pool based on a measurement result by the measurement unit 105; and a function for controlling time-frequency hopping.

The reservation controller 104 executes control related to the reservation described by referring to FIG. 9 and so forth. For example, the reservation controller 104 includes a function for managing a timer (e.g., to decrement a timer value); a function for indicating, upon detecting that the timer value becomes zero, the signal transmitter 101/signal receiver 102 to release the reserved resource, and so forth.

The measurement unit 105 allows the resource manager 103 to select a resource that does not collide with that of another UE by measuring received power, etc., of signals transmitted from the other UE.

<Hardware Configuration>

The block diagram (FIG. 16) used for describing the above-described embodiment shows blocks in units of functions. These functional blocks (components) are implemented by any combination of hardware and/or software. Furthermore, a means for implementing each functional block is not particularly limited. Namely, each functional block may be implemented by a single device that is physically and/or logically coupled; or may be implemented two or more devices by directly and/or indirectly (e.g., wired and/or wireless) connecting the two or more physically and/or logically separated devices.

For example, the user equipment UE according to the embodiment of the present invention may function as a computer for performing the process according to the embodiment of the present invention. FIG. 17 is a diagram showing an example of a hardware configuration of each of the base station eNB and the user equipment UE according to the embodiment of the present invention. The above-described user equipment UE may be physically configured as a computer device including a processor 1001; a memory 1002; a storage 1003; a communication device 1004; an input device 1005; an output device 1006; a bus 1007, and so forth.

Note that, in the following description, the term “device” can be replaced with a circuit, an apparatus, a unit, and so forth. The hardware configuration of the user equipment UE may be configured to include one or more devices that are depicted; or may be configured without including a part of the devices.

Each function in the user equipment UE is implemented by loading predetermined software (program) on hardware, such as the processor 1001 and the memory 1002, so that the processor 1001 performs an operation to control communication by the communication device 1004, and reading and/or writing data in the memory 1002 and the storage 1003.

The processor 1001, for example, operates an operating system to control the entire computer. The processor 1001 may be formed of a central processing unit (CPU: Central Processing Unit) including an interface with a peripheral device, a control device, a processing device, a register, and so forth. For example, the signal transmitter 101, the signal receiver 102, the resource manager 103, the reservation controller 104, and the measurement unit 105 of the user equipment UE may be implemented by the processor 1001.

Furthermore, the processor 1001 reads out a program (program code), a software module, or data from the storage 1003 and/or the communication device 1004 to the memory 1002; and executes various types of processes in accordance with these. As for the program, a program is used, which is for causing a computer to execute at least a part of the operation described in the above-described embodiment. For example, the signal transmitter 101, signal receiver 102, the resource manager 103, the reservation controller 104, and the measurement unit 105 may be implemented by a control program that is stored in the memory 1002 and operated by the processor 1001; and the other functional blocks may be implemented similarly. It is described that the above-described processes are executed by the single processor 1001; however, these may be executed simultaneously or sequentially by two or more processors 1001. The processor 1001 may be implemented by one or more chips. Note that the program may be transmitted from a network through an electric communication line.

The memory 1002 is a computer readable recording medium; and may be formed of, for example, at least one of a ROM (Read Only Memory), an EPROM (Erasable Programmable ROM), an EEPROM (Electrically Erasable Programmable ROM), a RAM (Random Access Memory), and so forth. The memory 1002 may be referred to as a register, a cache, a main memory (main storage device), and so forth. The memory 1002 is capable of storing a program (program code), a software module, and so forth, which can be executed for implementing the communication method according to the embodiment of the present invention.

The storage 1003 is a computer readable recording medium; and may be formed of, for example, at least one of an optical disk such as a CD-ROM (Compact Disc ROM), a hard disk drive, a flexible disc, a magneto-optical disk (for example, a compact disk, a digital versatile disk, a Blu-ray (registered trademark) disk), a smart card, a flash memory (e.g., a card, a stick, a key drive), Floppy (registered trademark) disk, a magnetic strip, and so forth. The storage 1003 may be referred to as an auxiliary storage device. The above-described storage medium may be, for example, a data base including the memory 1002 and/or the storage 1003, a server, or another suitable medium.

The communication device 1004 is hardware (transmission/reception device) for performing communication between computers through a wired and/or wireless network; and, for example, it is also referred to as a network device, a network controller, a network card, a communication module, and so forth. For example, the signal transmitter 101 and the signal receiver 102 of the user equipment UE may be implemented by the communication device 1004.

The input device 1005 is an input device (e.g., a keyboard, a mouse, a microphone, a switch, a button, a sensor, etc.) for receiving an input from outside. The output device 1006 is an output device (e.g., a display, a speaker, a LED lamp, etc.) that performs output to outside. Note that the input device 1005 and the output device 1006 may be integrated (e.g., a touch panel).

Furthermore, the devices, such as the processor 1001 and the memory 1002, are connected by the bus 1007 for communicating information. The bus 1007 may be formed of a single bus; or may be formed of buses that are different among the devices.

Furthermore, the user equipment UE may be formed to include hardware, such as a microprocessor, a digital signal processor (DSP: Digital Signal Processor), an ASIC (Application Specific Integrated Circuit), a PDL (Programmable Logic Device), and a FPGA (Field Programmable Gate Array); and the hardware may partially or entirely implement each functional block. For example, the processor 1001 may be implemented by at least one of these hardware components.

### Conclusion of the Embodiment

As described above, according to the embodiment, there is provided user equipment of a mobile communication system supporting D2D, the user equipment including a reservation unit that transmits reservation information including reservation resource identification information corresponding to a reservation resource used for data transmission by the user equipment; and a transmitter that transmits data using the reservation resource corresponding to the reservation resource identification information.

With the above-described configuration, in the communication system supporting D2D, D2D communication suitable for critical communication can be performed. Certainly, the above-described configuration can be applied to a communication that is not critical communication.

The reservation information may include information indicating a period for using the reservation resource between the user equipment and receiving user equipment that receives data transmitted from the user equipment. With this configuration, the receiving user equipment can find the period during which the resource is reserved.

Upon detecting expiration of the period for using the reservation resource, the reservation unit may select another reservation resource that is different from the reservation resource, and may transmit reservation information including reservation resource identification information corresponding to the other reservation resource. With this configuration, it can be avoided that the reservation continues for a long time.

Furthermore, a reservation period may be defined to be a period that is longer than a control period including a control information resource pool for transmitting the reservation information and a data resource pool for transmitting the data; and the transmitter may transmit data using the reservation resource at every control period, the control periods being spaced apart by the reservation period. With this configuration, a flexible transmission rate can be achieved.

The reservation unit may select, as the reservation resource, a resource with a fixed bandwidth. By using the resource with the fixed bandwidth in this manner, for example, measurement and reservation of resources can be easily performed.

The reservation unit may transmit the reservation information using a resource that is estimated not to be used by any other user equipment based on received power in the control information resource pool for transmitting the reservation information. With this configuration, the reservation information can be prevented from colliding with a signal transmitted from any other user equipment.

The reservation unit may select, as the reservation resource, a resource that is estimated not to be used by any other user equipment based on measurement of received power in the data resource pool for transmitting the data, or based on reservation information received from any other user equipment. With this configuration, it can be avoided that the data collides with a signal transmitted by the other user equipment.

Furthermore, the “unit” in the configuration of the above-described device may be replaced with “part,” “circuit,” “device,” and so forth.

The UE described in the embodiment may have a configuration that is implemented by executing a program by a CPU (processor) in the UE including the CPU and a memory; may have a configuration that is implemented by hardware provided with a logic for the process described in the embodiment, such as a hardware circuit; or may have a mixture of programs and hardware.

The eNB described in the embodiment may have a configuration that is implemented by executing a program by a CPU (processor) in the eNB including the CPU and a memory; may have a configuration that is implemented by hardware provided with a logic for the process described in the embodiment, such as a hardware circuit; or may have a mixture of programs and hardware.

The embodiment of the present invention is described above; however the disclosed invention is not limited to the embodiment, and a person ordinarily skilled in the art will appreciate various variations, modifications, alternatives, replacements, and so forth. Specific examples of numerical values are used in the description in order to facilitate understanding of the invention. However, these numerical values are merely an example, and any other appropriate values may be used, except as indicated otherwise. The separations of the items in the above description are not essential to the present invention. Depending on necessity, subject matter described in two or more items may be combined and used, and subject matter described in an item may be applied to subject matter described in another item (provided that they do not contradict). A boundary of a functional unit or a processor in the functional block diagrams may not necessarily correspond to a boundary of a physical component. An operation by a plurality of functional units may be physically executed by a single component, or an operation of a single functional unit may be physically executed by a plurality of components. For the convenience of description, the base station and the user equipment are described by using the functional block diagrams; however, such devices may be implemented in hardware, software, or combinations thereof. The software to be executed by the processor included in the user equipment and the base station in accordance with the embodiment of the present invention may be stored in any appropriate storage medium, such as a random access memory (RAM), a flash memory, a read-only memory (ROM), an EPROM, an EEPROM, a register, a hard disk drive (HDD), a removable disk, a CD-ROM, a database, a server, and so forth.

### Supplements to the Embodiment

Reporting of information is not limited to the aspects/embodiment described in this specification, and may be performed by another method. For example, reporting of information may be implemented by physical layer signaling (e.g., DCI (Downlink Control Information)), UCI (Uplink Control Information)), higher layer signaling (e.g., RRC signaling, MAC signaling, broadcast information (MIB (Master Information Block), SIB (System Information Block)), other signals or a combination thereof. Furthermore, the RRC message may be referred to as RRC signaling. Furthermore, the RRC message may be, for example, an RRC connection setup (RRC Connection Setup) message, an RRC connection reconfiguration (RRC Connection Reconfiguration) message, and so forth.

The aspects/embodiment described in the specification can be applied to LTE (Long Term Evolution); LTE-A (LTE-Advanced); SUPER 3G; IMT-Advanced; 4G; 5G; FRA (Future Radio Access); W-CDMA (registered trademark); GSM (registered trademark); CDMA 2000; UMB (Ultra Mobile Broadband); IEEE 802.11 (Wi-Fi); IEEE 802.16 (WiMAX); IEEE 802.20; UWB (Ultra-Wide Band); Bluetooth (registered trademark); a system that utilizes another suitable system and/or a next generation system evolved based on these.

The input/output information, etc., may be stored in a specific location (e.g., a memory), or may be managed by a management table. The input/output information, etc., may be overwritten, updated, or added. The output information, etc., may be deleted. The input information, etc. may be transmitted to another device.

The decision or determination may be performed by a value (0 or 1) represented by one bit; may be performed by a Boolean value (Boolean: true or false); or by numerical value comparison (e.g., a comparison with a predetermined value).

The information, signals, etc., described in the specification may be represented by using any of various different techniques. For example, the data, instruction, command, information, signal, bit, symbol, chip, etc., which may be referred to over the entire description above, may be represented by a voltage, an electric current, an electromagnetic wave, a magnetic field or magnetic particles, a light field or photons, or any combination thereof.

Note that the terms described in this specification and/or terms required for understanding the specification may be replaced with terms having the same or similar meanings. For example, a channel and/or a symbol may be a signal (signal). Furthermore, a signal may be a message.

The UE may be referred to, by a person skilled in the art, as a subscriber station; a mobile unit; a subscriber unit; a wireless unit; a remote unit; a mobile device; a wireless device; a wireless communication device; a remote device; a mobile subscriber station; an access terminal; a mobile terminal; a wireless terminal; a remote terminal; a handset; a user agent; a mobile client; a client; or some other suitable terms.

The order of the processing procedures, sequences, and so forth of the aspects/embodiment described in the specification may be re-arranged, provided that they do not contradict. For example, for the methods described in the specification, the elements of various steps are presented in an exemplary order, and are not limited to the specific order presented.

Each aspect/embodiment described in the specification may be used alone; may be used in combination; or may be used by switching depending on execution. Furthermore, reporting of predetermined information (e.g., reporting of “being X”) is not limited to the method of explicitly performing, and may be performed implicitly (e.g., not perform reporting of the predetermined information).

The terms “determine (determining)” and “decide (determining)” may encompass a wide variety of operations. The “determine” and “decide” may include, for example, “determine” and “decide” what is calculated (calculating), computed (computing), processed (processing), derived (deriving), investigated (investigating), looked up (looking up) (e.g., looked up in tables, databases, or other data structures), ascertained (ascertaining). Furthermore, the “determine” and “decide” may include deeming that “determination” and “decision” are made on reception (receiving) (e.g., receiving information), transmission (transmitting) (e.g., transmitting information), input (input), output (output), and access (accessing) (e.g., accessing data in a memory). Furthermore, the “determine” and “decide” may include deeming that “determination” and “decision” are made on what is resolved (resolving), selected (selecting), chosen (choosing), established (establishing), and compared (comparing). Namely, the “determine” and “decide” may include deeming that some operation is “determined” or “decided.”

The phrase “based on” used in this specification does not imply “based only on” unless explicitly stated otherwise. In other words, the phrase “based on” implies both “based only on” and “based at least on.”

The present invention is not limited to the above-described embodiment; and various variations, modifications, alternatives, replacements, and so forth are included in the present invention without departing from the spirit of the present invention.

This patent application is based upon and claims the benefit of priority of Japanese Patent Application No. 2015-160002 filed on Aug. 13, 2015, and the entire contents of Japanese Patent Application No. 2015-160002 are incorporated herein by reference.

### LIST OF REFERENCE SYMBOLS

eNB: base station
UE 1, UE 2: user equipment
101: signal transmitter
102: signal receiver
103: resource manager
104: reservation controller
105: measurement unit
1001: processor
1002: memory
1003: storage
1004: communication device
1005: input device
1006: output device

1. User equipment of a mobile communication system supporting D2D, the user equipment comprising:
a reservation unit that transmits reservation information including reservation resource identification information corresponding to a reservation resource used for data transmission by the user equipment; and
a transmitter that transmits data using the reservation resource corresponding to the reservation resource identification information.

2. The user equipment according to claim 1, wherein the reservation information includes information indicating a period for using the reservation resource between the user equipment and receiving user equipment that receives data transmitted from the user equipment.

3. The user equipment according to claim 2, wherein, upon detecting expiration of the period for using the reservation resource, the reservation unit selects another reservation resource that is different from the reservation resource, and transmits reservation information including reservation resource identification information corresponding to the other reservation resource.

4. The user equipment according to claim 1, wherein a reservation period is defined to be a period that is longer than a control period including a control information resource pool for transmitting the reservation information and a data resource pool for transmitting the data, and
wherein the transmitter transmits data using the reservation resource at every control period, the control periods being spaced apart by the reservation period.

5. The user equipment according to claim 1, wherein the reservation unit selects, as the reservation resource, a resource with a fixed bandwidth.

6. The user equipment according to claim 1, wherein the reservation unit transmits the reservation information using a resource that is estimated not to be used by any other user equipment based on received power in the control information resource pool for transmitting the reservation information.

7. The user equipment according to claim 1, wherein the reservation unit selects, as the reservation resource, a resource that is estimated not to be used by any other user equipment based on measurement of received power in the data resource pool for transmitting the data, or based on reservation information received from any other user equipment.

8. A data transmission method executed by user equipment of a mobile communication system supporting D2D, the data transmission method comprising:
a reservation step of transmitting reservation information including reservation resource identification information corresponding to a reservation resource used for data transmission by the user equipment; and
a transmission step of transmitting data using the reservation resource corresponding to the reservation resource identification information.
